(19) United States
(12) Patent Application Publication
(10) Pub. No.: US 2010/0007048 A1
(43) Pub. Date: Jan. 14, 2010

(54) METHOD FOR THE PRODUCTION OF A MULTI-LAYER PREFORM AND NOZZLE THEREFOR

(75) Inventors: Stefan Schweininger, Wiesbaden (DE); Christian Wagner, Mainz (DE); Rainer Petry, Klein-Winternheim (DE); Erich Winkler, Bruchkoebel (DE)

Correspondence Address: MICHAEL L. DUNN, SIMPSON & SIMPSON, PLLC, 5555 MAIN STREET, WILLIAMSVILLE, NY, 14221, US

(73) Assignee: MHT Mold & Hotrunner Technology AG, Hochheim (DE)

(21) Appl. No.: 12/310,239

(22) PCT Filed: Jul. 30, 2007
(86) PCT No.: PCT/EP2007/057814

§ 371 Date: Aug. 21, 2009

(30) Foreign Application Priority Data
Aug. 26, 2006 (DE) 10 2006 040 182.4

(51) Int. Cl. B29C 45/16

(52) U.S. Cl. 264/241; 425/133.1

(57) ABSTRACT

A melt feed device for an injection molding apparatus having at least one nozzle element connected both to a first hot runner and a second hot runner for feeding both the first melt and the second melt into an injection molding mold. The nozzle has three substantially concentrically arranged feed passages, wherein the innermost and the outermost feed passage are in communication with the first hot runner and the central feed passage is in communication with the second hot runner. A closure element is provided that can be reciprocated between a first position in which the closure element closes all feed passages, a second position in which the closure element opens the outermost feed passage but closes the other two feed passages and a third position in which the closure element opens all feed passages. The invention also includes process and molds using the device.

### BACKGROUND OF THE INVENTION

The present invention concerns a process for the production of a multi-layer parison and a nozzle for same.

Particularly in the production of PET bottles it is usual firstly to produce what is referred to as a preform or parison which in a further process step is inflated to give the definitive bottle shape. The injection molding process can be used for production of the preform. Here the liquid molten material is injected under pressure into a corresponding mold tool, also referred to as a mold cavity structure.

The known PET bottles are primarily used for packaging liquid foodstuffs, for example drinking water. The walls of such PET bottles however are transmissive, for example, for low-molecular gases so that the perishability of the packaged foodstuffs is limited thereby. In addition PET bottles are generally transparent, which is disadvantageous for light-sensitive products.

It is therefore occasionally already usual for the inside or outside of the PET bottles to be coated with what is referred to as a barrier layer. That barrier layer provides that for example oxygen or carbon dioxide can pass through the container wall, to a markedly lesser degree. In alternative embodiments the barrier layer can also be a barrier in relation to electromagnetic radiation in the visible wavelength range or in the UV range as some foodstuffs are sensitive to light irradiation.

It has already been proposed for the barrier layer to be applied during blowing of the parison to form a finished PET bottle. Then, in the blow molding of PET bottles, instead of compressed air, for example oxyhydrogen gas (a mixture of hydrogen and oxygen) is used, with further constituents already being added to form the barrier layer. Then in one step, by igniting the explosive mixture, the previously heated preform is urged into the blown shape and a barrier layer is formed at the inside.

The known processes for coating the inside and/or outside of the PET bottles however suffer from the disadvantage that on the one hand the barrier layer must consist exclusively of non-toxic, taste-neutral substances and in addition the coating can be easily damaged.

It has therefore already been proposed for the parison to be produced in a multi-layer configuration so that a suitable barrier layer is automatically formed after the parison is blown to give a PET bottle.

A suitable nozzle for the injection of two melts of different materials is described for example in EP 1 426 160. That melt feed device comprises two mutually concentrically arranged feed passages through which the melts of different injection molding material can be fed into the mold cavity structure.

That mold feed device however suffers from the disadvantage that metering of the barrier material is only highly inaccurately effected. In addition it is not possible with that device to produce a three-layer structure in which the barrier is disposed uniformly between two PET layers. Furthermore it has happened that the individual layers delaminate again, which makes the PET bottle useless.

### BRIEF SUMMARY OF THE INVENTION

The invention includes a melt feed device for an injection molding apparatus having a first hot runner for feeding a melt of a first injection molding material under pressure and a second hot runner for feeding a melt of a second injection molding material. At least one nozzle element is provided connected both to the first hot runner and also to the second hot runner for feeding both the first melt and the second melt into an injection molding mold.

The nozzle has three substantially concentrically arranged feed passages, wherein the innermost and the outermost feed passage are in communication with the first hot runner and the central feed passage is in communication with the second hot runner. A closure element is provided that can be reciprocated between a first position in which the closure element closes all feed passages, a second position in which the closure element opens the outermost feed passage but closes the other two feed passages and a third position in which the closure element opens all feed passages.

### BRIEF DESCRIPTION OF THE SEVERAL VIEWS OF THE DRAWINGS

FIG. 1 shows a cross-sectional view of an embodiment of the melt feed device according to the invention,

FIG. 2 shows a cross-sectional view of the melt feed device of FIG. 1, wherein the outer and inner feed passages are filled with PET material,

FIG. 3 shows a cross-sectional view, wherein the central feed passage is filled with injection molding material and the closure needle is in the first position,

FIG. 3a shows a view on an enlarged scale of a detail from FIG. 3,

FIG. 4 shows a cross-sectional view corresponding to FIG. 3, wherein the closure needle is in the second position,

FIG. 5 shows a cross-sectional view corresponding to FIG. 3, wherein the closure needle is in the third position,

FIG. 6 shows a cross-sectional view corresponding to the view of FIG. 5, wherein the metering chamber is completely emptied and the closure needle is in the second position, and

FIG. 7 shows a cross-sectional view in which the closure needle is again in the first position.

### DETAILED DESCRIPTION OF THE INVENTION

The object of the present invention is to provide a co-injection process and a melt feed device for an injection molding apparatus, with which a parison comprising at least three layers can be produced, wherein quite particularly the barrier layer can be exactly metered.

According to the invention that object is attained by a melt feed device for an injection molding apparatus comprising a first hot runner for feeding a melt of a first injection molding material under pressure and a second hot runner for feeding a melt of a second injection molding material and at least one nozzle element connected both to the first hot runner and also to the second hot runner for feeding both the first melt and also the second melt into an injection molding mold, wherein the at least one nozzle element has three substantially concentrically arranged feed passages, wherein the innermost and the outermost feed passage are in communication with the first hot runner and the central feed passage is in communication with the second hot runner wherein moreover there is provided a closure element which can be reciprocated between a first position in which the closure element closes all feed passages, a second position in which the closure element opens the outermost feed passage but closes the other two feed passages, and a third position in which the closure element opens all feed passages.

With such a melt feed device it is possible firstly to open only the outer feed passage so that only the first injection molding material, for example PET, is introduced into the mold cavity structure. That material is provided for example for forming the screwthread portion in which no barrier layer is needed. As soon as sufficient material for the screwthread portion has been introduced into the mold cavity structure the closure element can be opened to such an extent that now all three concentric, substantially annular feed passages are open. In that position a three-layer melt is introduced into the mold cavity structure, with the barrier layer being arranged in the center.

In a particularly preferred embodiment the second hot runner is connected to a metering chamber, the volume of which can be adjusted by means of a displacement element. The amount of the second injected material can be highly accurately metered by the use of the metering chamber. It is generally sufficient for the barrier function if the barrier layer constitutes 5% of the total volume of the parison or less.

In a preferred embodiment the metering chamber has a metering piston operating as the displacement element. By means of the metering piston, then both the size of the metering chamber can be adjusted and also the material introduced into the metering chamber can be transferred into the mold cavity structure by way of the central feed passage.

It has proven to be advantageous if a separate metering chamber is associated with each nozzle element. That measure ensures that the metering chamber can be arranged very close to the mold cavity structure so that highly exact metering can be effected. In contrast thereto metering chambers are known in the state of the art, which are provided for the feed of the second melt to a plurality of mold cavity structures.

In a further preferred embodiment there are provided at least two nozzle elements, wherein the displacement devices of the at least two nozzle elements are connected to a common metering plate so that the volume of the metering chambers of the at least two nozzle elements can be jointly and synchronously adjusted by movement of the metering plate relative to the metering chamber. As generally there is a need for the production of a large number of parisons, the described measure provides that an entire row of metering pistons can be moved by movement of the metering plate so that the corresponding metering action can be effected simultaneously in an entire row of mutually juxtaposed mold cavity structures.

It is particularly desirable if the metering chamber is arranged in the nozzle element as then the passage length between the metering chamber and the feed passage can be correspondingly short.

It is further advantageous if the first and second hot runner are guided in separate tool portions (also referred to as a hot runner plate). As frequently the optimum processing temperature for the different injection molding materials differs the separate hot runner tool elements can be kept at different temperatures so that the optimum processing temperature is always ensured for each injection molding material. It may further be advantageous if the first and second hot runners are subjected to the action of different pressures.

In a particularly preferred embodiment the closure element is a closure needle, by means of which at least one of the feed passages and preferably all feed passages can be closed.

Furthermore in a preferred embodiment there are provided at least two nozzle elements whose closure needles are connected to a common control plate so that the closure needles can be moved jointly and synchronously by movement of that plate.

In that respect advantageously the displacement device and the closure needle are so arranged that the directions of movement thereof for displacement of the metering chamber and for closure of the feed passages respectively are parallel to each other. That permits particularly simple control of the tool.

Furthermore a particularly preferred embodiment provides that the metering chamber is arranged in the flow direction between the second hot runner and the outlet of the central feed passage. In other words the metering chamber is arranged neither in the hot runner tool portion nor at the outlet of the central feed passage.

In regard to the process the aforementioned object is attained in that firstly there is provided a mold cavity structure, a first melt comprising a first injection molding material is first fed into the mold cavity structure, than a melt comprising at least three layers is fed, wherein the two outer layers are of a first injection molding material and the central layer is of a second injection molding material, and finally once again only the first melt of a first injection molding material is fed into the mold cavity structure.

Further advantages, features and possible uses of the present invention will be apparent from the description hereinafter of a preferred embodiment and the accompanying drawings.

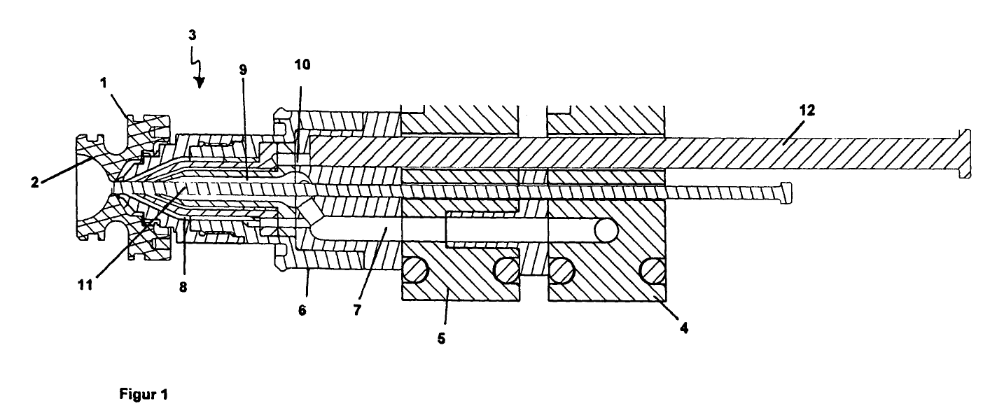

FIG. 1 shows a particularly preferred embodiment of the melt feed device according to the invention.

It is possible to see the base insert 1 of a mold cavity structure. The mold cavity structure forms a hollow space which is filled with the liquid melt to produce a parison. The hollow space adjoins the base insert 1 at the left in FIG. 1. The contour 2 of the base insert 1 forms the outside contour of the base of the preform. The base insert 1 has a gate or port through which the liquid melt can pass into the hollow space.

The melt feed device 3 of the invention is for feeding the liquid melt. The melt feed device 3 has a first hot runner tool portion 4 in which the first hot runner is provided, a second hot runner tool portion 5 in which the second hot runner is provided, and a nozzle element 6. A first melt comprising a first material, for example PET, is fed by way of the first hot runner (in the hot runner tool portion 4). The second hot runner (in the second hot runner tool portion 5) serves for feeding a second melt comprising a different material, for example PA- or PE-based plastic materials.

Extending from the first hot runner (in the hot runner tool portion 4) is a first feed passage 7 which branches into an outer feed passage 8 and an inner feed passage 9.

The second hot runner (in the second hot runner tool portion 5) is connected to the central feed passage 10. The three feed passages 8, 9, 10 are of an annular configuration and arranged concentrically around a closure needle 11. It is further possible to see a metering piston 12, the function of which is described in greater detail hereinafter.

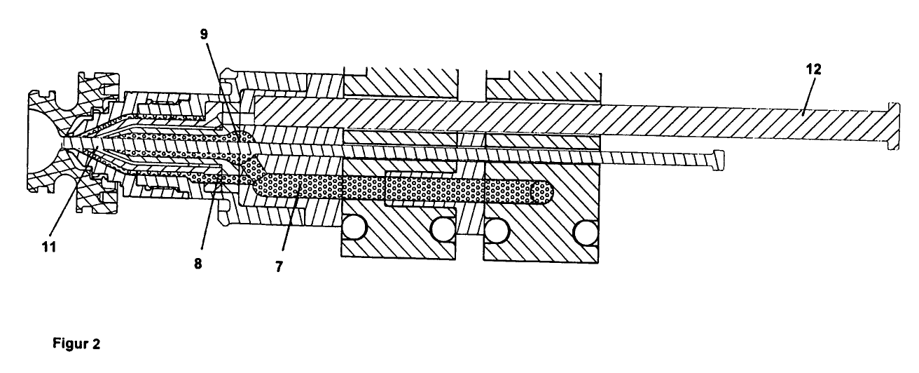

FIG. 2 substantially corresponds to FIG. 1, with the feed passage 7 with its two branches 8 and 9 here being filled with the first injection molding material, for example PET. It can be clearly seen that the feed passages 8, 9 arranged concentrically around the closure needle have their exit directly at the closure needle 11.

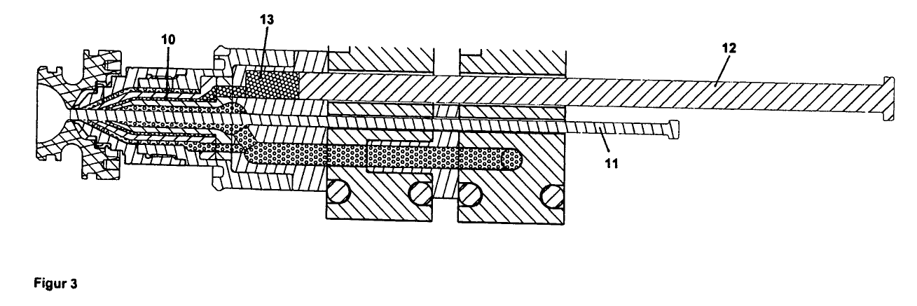

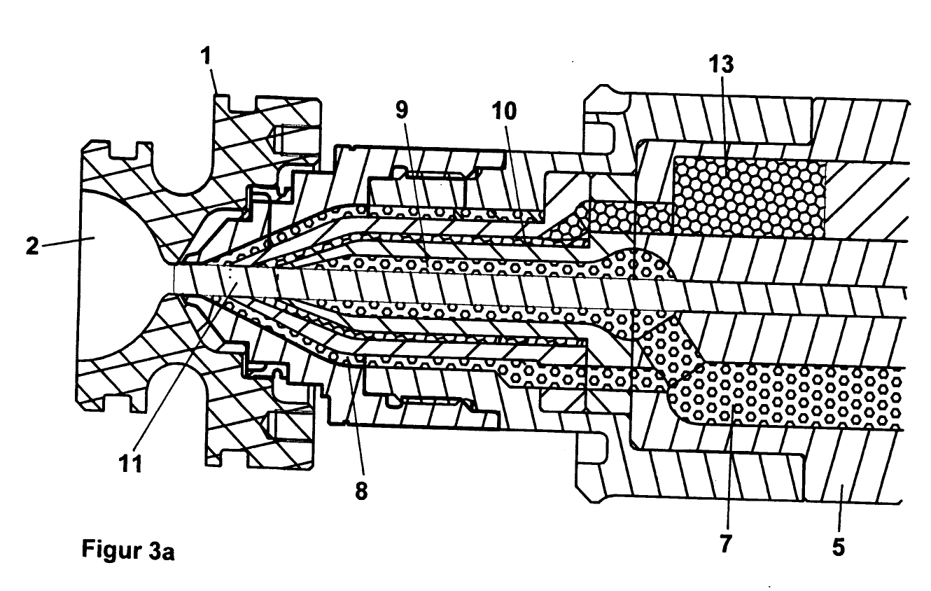

To feed the second injection molding material from which the barrier layer is to be made, firstly the metering piston 12 is moved from the FIG. 1 position into the FIG. 3 position. That results in opening of the metering chamber 13 through which the second injection molding material is introduced. It flows into the central feed passage 10 which extends also as far as the closure needle 11.

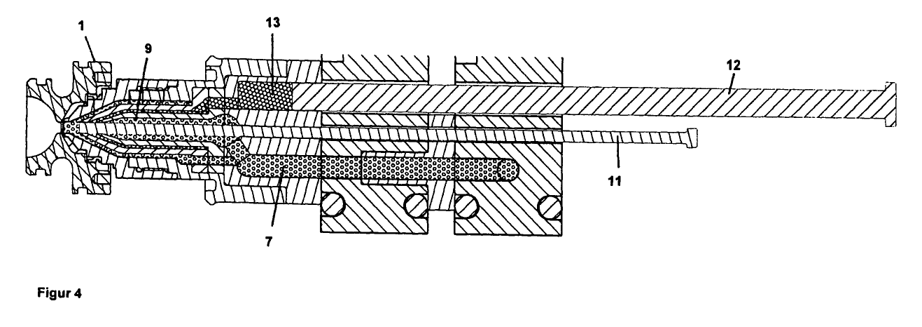

In order now to produce a multi-layer parison firstly the closure needle 11 is moved from the first position shown in FIG. 3 in which the closure needle 11 closes all three feed passages 8, 9 and 10 into the second position shown in FIG. 4 in which the closure needle 11 is retracted (towards the right in FIG. 4) to such an extent that the outer feed passage 9 is opened so that the first melt can penetrate by way of the outer feed passage into the mold cavity structure by way of the base insert 1. In that position only one melt is introduced into the mold cavity structure. That melt serves to form the screwthread portion (not shown) of the parison as the barrier layer is not necessary here and generally results in a reduction in the stability of the screwthread of the parisons. In addition delamination of the individual layers can occur so that it is advantageous if the barrier layer is bound as completely as possible in the PET base material.

For the sake of enhanced clarification FIG. 3a shows the melt feed device and in particular the nozzle element 6 once again as a detail on an enlarged scale.

In the position shown in FIG. 4 the first melt can now be fed by way of an extruder screw connected to the feed passage 7 or by way of a corresponding metering piston until substantially the amount of material which is necessary for forming the screwthread portion has been introduced into the mold cavity structure.

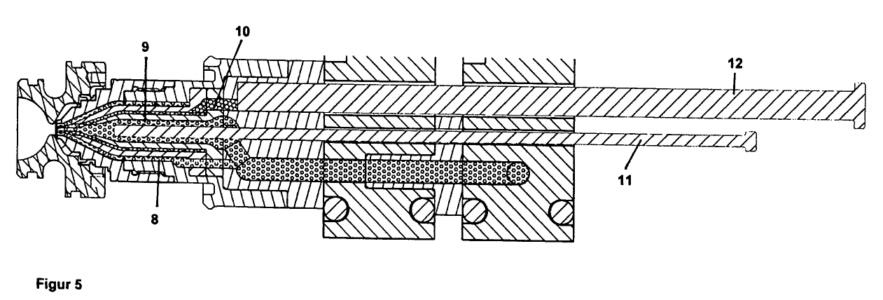

Now in the next step the closure needle 11 is moved from the second position shown in FIG. 4 into the third position shown in FIG. 5. In that third position the closure needle 11 is pulled rearwardly to such an extent that now all three concentrically arranged feed passages 8, 9, 10 are open. The first injection molding material is now transferred into the mold cavity structure by way of the outer and inner feed passages 8, 9.

In order also to transfer the second injection molding material which is in the metering chamber 13 into the mold cavity structure the metering piston 12 is now moved in the direction of the metering chamber 13 so that the material therein is discharged into the mold cavity structure by way of the central feed passage 10.

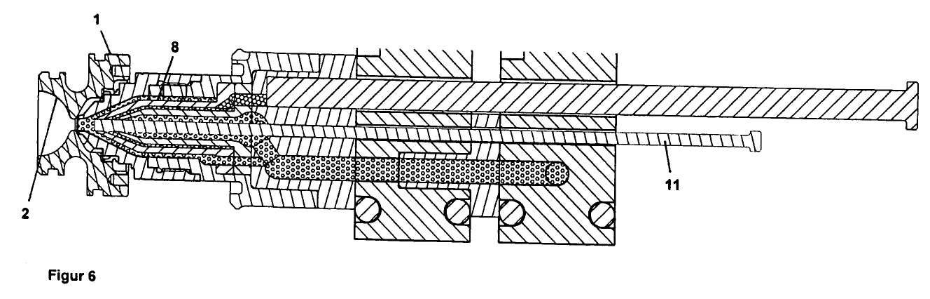

Finally in a further step shown in FIG. 6 the closure needle 11 is moved from the third position back into the second position in which again it is only the outer feed passage 8 that is opened while the other two feed passages 9, 10 are closed. Now exclusively the first injection molding material is again introduced into the mold cavity structure. The result of this is that the lowermost portion of the parison which comes into contact with the base insert 1 is portion-wise of an only single-layer configuration. That ensures that no barrier material is present in the feedhead region, that is to say in the base of the parison. That reduces the risk of bursting of the parison during the subsequent stretch blow molding step.

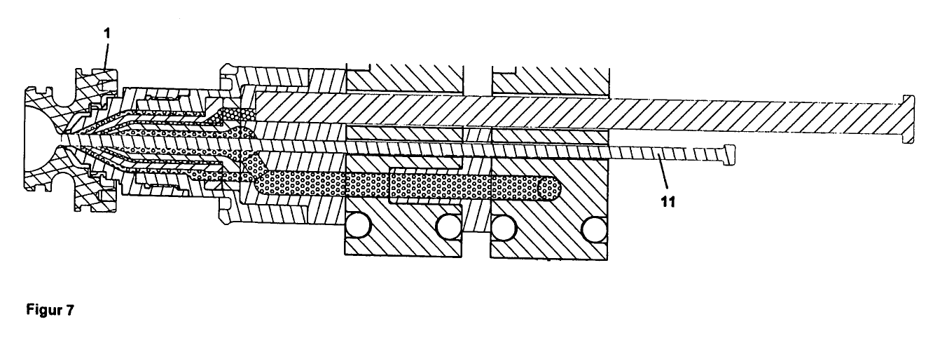

Finally, as shown in FIG. 7, the injection molding operation is terminated by the closure needle 11 being moved again into its first position which closes all feed passages and thus the gates of the base insert 1.

As soon as the parison has sufficiently cooled in the mold cavity structure the parison can be removed, the mold cavity structure closed again and the injection molding operation begins afresh.

### LIST OF REFERENCES

1 base insert
2 contour of the base insert
3 melt feed device
4 first hot runner tool portion
5 second hot runner tool portion
6 nozzle element
7 first feed passage
8 outer feed passage
9 inner feed passage
10 central feed passage
11 closure needle
12 metering piston
13 metering chamber

What is claimed is:

1-14. (canceled)

15. A melt feed device for an injection molding apparatus comprising a first hot runner (4) for feeding a melt of a first injection molding material under pressure and a second hot runner (5) for feeding a melt of a second injection molding material and at least one nozzle element (6) connected both to the first hot runner (4) and to the second hot runner (5) for feeding both the first melt and the second melt into an injection molding mold, wherein the at least one nozzle element (6) has three substantially concentrically arranged feed passages being an outermost feed passage (8) and an innermost (9) feed passage in communication with the first hot runner (4), both of the outermost feed passage (8) and inner feed passage (9) being connected to supply feed passage (7) and a central feed passage (10) in communication with the second hot runner (5), wherein a closure element (11) is provided that can be reciprocated between a first position in which the closure element closes feed passages (8, 9, 10), a second position in which the closure element opens the outermost feed passage (8) but closes feed passages (9, 10), and a third position in which the closure element (11) opens feed passages (8, 9, 10).

16. A melt feed device as set forth in claim 15 wherein the second hot runner (5) is connected to a metering chamber (13), the volume of which can be adjusted by means of a displacement element (12).

17. A melt feed device as set forth in claim 16 wherein the metering chamber has a metering piston (12) operating as the displacement element.

18. A melt feed device as set forth in claim 16 wherein a separate metering chamber (13) is associated with each nozzle element (6).

19. A melt feed device claim 18 wherein there are provided at least two nozzle elements (6), wherein the displacement devices of the at least two nozzle elements (6) are connected to a common metering plate so that the volume of the metering chambers (13) of the at least two nozzle elements (6) can be jointly and synchronously adjusted by movement of the metering plate relative to the metering chamber (13).

20. A melt feed device as set forth in claim 18 wherein metering chambers (13) are arranged in their respective the nozzle elements (6).

21. A melt feed device as set forth in claim 15 wherein the first hot runner (4) and second hot runner (5) are guided in separate tool portions.

22. A melt feed device as set forth in claim 15 wherein the closure element is a closure needle (11), that can close at least one of the feed passages (8, 9, 10).

23. A melt feed device as set forth in claim 16 wherein the closure element is a closure needle (11), that can close at least one of the feed passages (8, 9, 10).

24. A melt feed device as set forth in claim 23 wherein the closure element is a closure needle (11), that can close all of the outer inner, and central feed passages (8, 9, 10).

25. A melt feed device as set forth in claim 23 wherein at least two nozzle elements (6) are provided whose closure needles (11) are connected to a common control plate so that the closure needles (11) can be moved jointly and synchronously by movement of the control plate.

26. A melt feed device as set forth in claim 23 wherein the displacement device and the closure needle (11) are so arranged that the directions of movement thereof for displacement of the metering chamber (13) and for closure of the feed passages (8, 9, 10) respectively are parallel to each other.

27. A melt feed device as set forth in claim 16 wherein the metering chamber (13) is arranged between the second hot runner (5) and the central feed passage (10).

28. An injection molding apparatus for the production of a molding having a melt feed device as set forth in claim 15.

29. An injection molding apparatus for the production of a molding having a melt feed device as set forth in claim 16.

30. A injection molding apparatus for the production of a molding having a melt feed device as set forth in claim 23.

31. A process for the production of a multi-layer parison which successively comprises the following steps:
providing a mold cavity structure,
feeding a melt of a first injection molding material into the mold cavity structure,
feeding a melt comprising at least three layers, wherein the two outer layers are of a first injection molding material and the central layer is of a second injection molding material, and
feeding a melt comprising a first injection molding material into the mold cavity structure.

32. A process as set forth in claim 31 wherein a melt feed device having three substantially mutually concentrically arranged feed passages is used, wherein the feed of a melt comprising a first injection molding material into the mold cavity structure is effected by feeding the melt by way of the outermost feed passage, and the feed of a melt comprising at least three layers, wherein the two outer layers comprise a first injection molding material and the central layer comprises a second injection molding material, is effected by way of all three feed passages.
